(19) United States
(12) Patent Application Publication
(10) Pub. No.: US 2023/0235952 A1
(43) Pub. Date: Jul. 27, 2023

(54) SEPARATE QUICK-FREEZING EQUIPMENT

(71) Applicant: Wuyi University, Jiangmen (CN)

(72) Inventors: Min WU, Jiangmen (CN); Rongmei HE, Jiangmen (CN); He CUI, Jiangmen (CN)

(21) Appl. No.: 17/841,021

(22) Filed: Jun. 15, 2022

(30) Foreign Application Priority Data
Jan. 27, 2022 (CN) 2022101017930

(51) Int. Cl. F25D 31/00; F25B 41/31; F25D 17/02; A23L 3/36

(52) U.S. Cl. CPC F25D 31/00; F25B 41/31; F25D 17/02; A23L 3/363; F25B 2400/23; A23V 2002/00

(57) ABSTRACT

A separate quick-freezing equipment is disclosed, including an evaporator, a condenser, a blower device and a quick-freezing device. The evaporator has a refrigerant inlet and a refrigerant outlet, the condenser is provided with a condensation cavity, a gas inlet, a gas outlet and a liquid outlet, the condensation cavity is internally provided with a molecular sieve assembly deposed between the gas inlet and the gas outlet; the refrigerant outlet is connected to the gas inlet by means of a gas returning pipe, the liquid outlet is connected to the refrigerant inlet by means of a liquid inlet pipe, the liquid inlet pipe is provided with a throttling assembly, the gas outlet is connected to the refrigerant inlet by means of a gas inlet pipe, and the blower device is communicated with the gas returning pipe; the quick-freezing device includes a liquid storage tank and a quick-freezing box.

### CROSS-REFERENCE TO RELATED APPLICATIONS

The present disclosure claims priority to and the benefit of Chinese Patent Application No. 202210101793.0 filed Jan. 27, 2022, the contents of which are incorporated herein by reference.

### TECHNICAL FIELD

The present disclosure relates to the technical field of refrigeration, in particular to a separate quick-freezing equipment.

### BACKGROUND

Quick-freezing of vegetables, fruits, seafood, meat and other food materials is to make frozen food by quick freezing after fresh food materials are processed, having the advantages of long-term storage, maintenance of original color, taste and various nutrients of food materials to a greater extent, and effective mediation of the supply for low and peak seasons.

In the related technology, a cold storage can be used for the quick-freezing of food materials. However, cold air circulation is adopted in the cold storage to cause long freezing time and poor preservation effect. Liquid nitrogen can be also used for quick cooling, which is extremely high in the cost and not conducive to large-scale operation.

### SUMMARY

The present disclosure aims to at least solve one of the technical problems in the prior art. For this purpose, the present disclosure proposes a separate quick-freezing equipment, which can realize the quick-freezing of food materials at a low cost.

A separate quick-freezing equipment according to the embodiments of the present disclosure, including an evaporator, a condenser, a blower device and a quick-freezing device, wherein the evaporator has a refrigerant inlet and a refrigerant outlet, the condenser is provided with a condensation cavity, a gas inlet, a gas outlet and a liquid outlet, and the condensation cavity is internally provided with a molecular sieve assembly, which is disposed between the gas inlet and the gas outlet and used for separating mixed gas; the refrigerant outlet is connected to the gas inlet by means of a gas returning pipe, the liquid outlet is connected to the refrigerant inlet by means of a liquid inlet pipe, the liquid inlet pipe is provided with a throttling assembly, the gas outlet is connected to the refrigerant inlet by means of a gas inlet pipe, and the blower device is communicated with the gas returning pipe for introducing the mixed gas into the condensation cavity; the quick-freezing device includes a liquid storage tank and a quick-freezing box, the liquid storage tank is used for storing a first salt solution, the evaporator is located at the lower part of an inner cavity of the liquid storage tank, the quick-freezing box is located at the upper part of the inner cavity of the liquid storage tank, the quick-freezing box is used for storing a sodium chloride solution, the quick-freezing box is connected with a circulating pipe, both ends of the circulating pipe are communicated with the inner cavity of the liquid storage tank, and the circulating pipe is provided with a heat exchange component located in the quick-freezing box.

The separate quick-freezing equipment according to the embodiments of the present disclosure has at least the beneficial effects as follows: by mixing a liquid refrigerant and gas with reduced pressure by means of the evaporator, the surface pressure of the liquid refrigerant reduces, such that the liquid refrigerant produces steam to be in a new dynamic equilibrium and an evaporation of the refrigerant is realized; by using the evaporation and heat absorption characteristics of the refrigerant, the heat of the first salt solution in the liquid storage tank is absorbed to prepare the first salt solution of low temperature, and the first salt solution flows in the circulating pipe; in the inner cavity of the quick-freezing box, the first salt solution and the sodium chloride solution are subjected to heat exchange by means of the heat exchange component so that the sodium chloride solution in the quick-freezing box drops to a low temperature, and the sodium chloride solution may maintain in a liquid form below zero and is edible to be safe in contact with food materials, so that the freezing of food materials is quickly realized by using the low-temperature sodium chloride solution, and quick freezing is realized; compared with liquid nitrogen quick freezing, the cost is greatly reduced, and the needs of large-scale operation are met; the refrigerant and the gas with reduced pressure are separated by means of the molecular sieve assembly in the condenser, and the condensation of the refrigerant is achieved after the refrigerant reaches a certain concentration to become a liquid refrigerant and re-enter into the evaporator for refrigeration.

According to some embodiments of the present disclosure, the circulating pipe is connected with a driving pump, which is located at an inlet end of the circulating pipe.

According to some embodiments of the present disclosure, the inlet end of the circulating pipe is communicated with the lower part of the inner cavity of the liquid storage tank, an outlet end of the circulating pipe is communicated with the upper part of the inner cavity of the liquid storage tank, and the inlet end and outlet end of the circulating pipe are located at two opposite sides of the liquid storage tank.

According to some embodiments of the present disclosure, the heat exchange component is configured as a heat exchange coil, which is located at the lower part of the inner cavity of the quick-freezing box.

According to some embodiments of the present disclosure, the quick-freezing box is connected with a liquid driving module, and the liquid driving module has a propeller, which is located in the inner cavity of the quick-freezing box to drive the flow of the sodium chloride solution.

According to some embodiments of the present disclosure, the quick-freezing device also includes a food material box, which is used for storing food materials and made of wire gauze and can be placed into the inner cavity of the quick-freezing box and has a handle.

According to some embodiments of the present disclosure, the liquid inlet pipe includes a liquid storage section, which includes at least one U-shaped pipes.

According to some embodiments of the present disclosure, the condenser is connected with a heat dissipating device for heat dissipation, and the heat dissipating device includes a cooling water pipe, which is wrapped at outside of the condenser.

According to some embodiments of the present disclosure, the gas outlet is located at the upper part of the condenser, the liquid outlet is located at the lower part of the condenser, the gas inlet is located at the middle part of the condenser, the condenser includes a tapered guiding portion, and the gas outlet is located at a small end of the tapered guiding portion.

According to some embodiments of the present disclosure, a port of the gas inlet pipe extends into the liquid inlet pipe, and projects from an inner wall of the liquid inlet pipe.

Additional aspects and advantages of the present disclosure will be given in part in the following description, and the aspects and advantages will become apparent from the following description, or learned by practice of the present disclosure.

### BRIEF DESCRIPTION OF DRAWINGS

Additional aspects and advantages of the present disclosure will become apparent and readily understood in conjunction with the description of the embodiments in the following drawings, wherein

FIG. 1 is a structural schematic diagram of the separate quick-freezing equipment according to some embodiments of the present disclosure;

FIG. 2 is a structural schematic diagram of the separate quick-freezing equipment according to some other embodiments of the present disclosure; and

FIG. 3 is a structural schematic diagram of the separate quick-freezing equipment according to some other embodiments of the present disclosure.

### DETAILED DESCRIPTION

Embodiments of the present disclosure will be described in detail below, and examples of the embodiments are shown in the accompanying drawings, wherein throughout the same or similar reference numerals denote the same or similar elements or elements having the same or similar functions. The following embodiments described with reference to the accompanying drawings are exemplary and serve only to explain the present disclosure, and should not be construed as limiting the present disclosure.

In the description of the present disclosure, it is to be understood that, referring to orientation description, the instructed orientation or positional relationships, for example, upper, lower, front, rear, left, right, etc., are based on the orientation or positional relationships shown in the drawings, merely for ease of description of the present disclosure and simplification for the description, rather than indicating or implying that the device or element referred to must have a specific orientation and being constructed and operated in a specific orientation, which, therefore, cannot be construed as limiting the present disclosure.

In the description of the present disclosure, unless explicitly defined otherwise, providing, installing, connecting and other words should be understood broadly, and a person skilled in the art can reasonably determine the specific meaning of the above words in the present disclosure combined with the specific content of the technical solution.

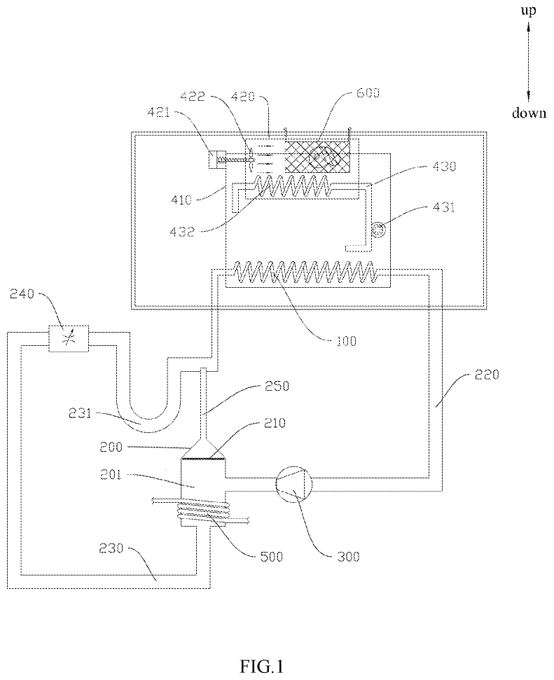

Referring to FIG. 1, the embodiments of the present disclosure propose a separate quick-freezing equipment, including a evaporator 100, a condenser 200, a blower device 300 and a quick-freezing device, wherein the evaporator 100 has a refrigerant inlet and a refrigerant outlet, the condenser 200 is provided with a condensation cavity 201, a gas inlet, a gas outlet and a liquid outlet, and the condensation cavity 201 is provided with a molecular sieve assembly 210, which is disposed between the gas inlet and the gas outlet and used for separating mixed gas; the refrigerant outlet is connected to the gas inlet by means of a gas returning pipe 220, the liquid outlet is connected to the refrigerant inlet by means of a liquid inlet pipe 230, the liquid inlet pipe 230 is provided with a throttling assembly 240, the gas outlet is connected to the refrigerant inlet by means of a gas inlet pipe 250, and the blower device 300 is communicated with the gas returning pipe 220 for introducing the mixed gas into the condensation cavity 201; the quick-freezing device includes a liquid storage tank 410 and a quick-freezing box 420, the liquid storage tank 410 is used for storing a first salt solution, the evaporator 100 is located at the lower part of the inner cavity of the liquid storage tank 410, the quick-freezing box 420 is located at the upper part of the inner cavity of the liquid storage tank 410, the quick-freezing box 420 is used for storing a sodium chloride solution, the quick-freezing box 420 is connected with a circulating pipe 430, both ends of the circulating pipe 430 are communicated with the inner cavity of the liquid storage tank 410, and the circulating pipe 430 is provided with a heat exchange component 432 located within the quick-freezing box 420.

It can be understood that, the first salt solution can use a calcium chloride solution, which may still not be frozen at minus 60 degrees, and in contrast, the sodium chloride solution is frozen at minus 23 degrees; the calcium chloride solution has a strong low-temperature resistance performance and can maintain flowing at a low temperature, and thus, the calcium chloride solution is used for the first heat exchange with the evaporator 100, while the sodium chloride solution in the quick-freezing box 420 is used for contact with food materials to ensure safety and avoid affecting the cooking of food materials after thawing. Of course, other salt solutions may be adopted as the first salt solution, and the disclosure will be illustrated below by an example in which adopting the calcium chloride solution as the first salt solution.

When the separate quick-freezing equipment is operating, a liquid refrigerant and gas with reduced pressure are mixed by means of the evaporator 100, specifically, the liquid refrigerant and the gas with reduced pressure are mixed in a pipeline of the evaporator 100; in a position at which the liquid refrigerant and the gas with reduced pressure start to mix, the evaporator 100 provides a space for evaporation; and there is no gaseous refrigerant at this mixing position, that is to say the partial pressure of the gaseous refrigerant is zero, thus the liquid refrigerant certainly evaporates to form a gaseous refrigerant. During this process, heat of the calcium chloride solution in the liquid storage tank 410 is absorbed, and a calcium chloride solution of low temperature is prepared.

The mixed gas formed by the gaseous refrigerant and the gas with reduced pressure flows into the condenser 200 along the gas returning pipe 220, the blower device 300 drives the mixed gas and introduces same into the condensation cavity 201 of the condenser 200. The condensation cavity 201 is internally provided with a molecular sieve assembly 210, which is defined as a novel material capable of achieving molecular sieving and has a uniform pore size comparable to molecular size, ion exchange property, high-temperature thermal stability, good shape selective catalytic performance and easy modification, and multiple different types and different structures for selection. The molecular sieve assembly 210 is configured to permit a passage of the gas with reduced pressure and block a passage of the refrigerant, thus achieving the effect of separating the mixed gas.

For example, ammonia is selected as the refrigerant, hydrogen or helium is selected as the gas with reduced pressure, the molecular diameter of hydrogen is 0.289 nanometer, namely 2.89 A; the molecular diameter of helium 0.26 nanometer, namely 2.6 A; and the molecular diameter of ammonia is 0.444 nanometer, namely 4.44 A. Therefore, a molecular sieve assembly 210 of 3 A or 4 A, for example a molecular sieve membrane, is selected, which can effectively separating hydrogen and ammonia, or separating helium and ammonia.

The nature of gaseous refrigerant liquefaction lies in that: after the relative humidity reaches 100%, the gaseous refrigerant will certainly be liquefied. Therefore, after separating the mixed gas, a partial space of the condensation cavity 201 only retains the gaseous refrigerant, or the gaseous refrigerant and the liquid refrigerant exist at the same time; and when the blower device 300 continues to introduce the mixed gas into the condensation cavity 201 of the condenser 200, the relative humidity of the gaseous refrigerant reaches 100%, and the gaseous refrigerant automatically condenses to a liquid refrigerant.

The working process of the separate quick-freezing equipment will be illustrated by an example in which selecting ammonia as the refrigerant and selecting hydrogen as the gas with reduced pressure.

Under the action of the blower device 300, the mixed gas of ammonia and hydrogen is introduced into the condensation cavity 201 from the gas inlet of the condenser 200. Hydrogen passes through the molecular sieve assembly 210 and flows out of the gas outlet, whereas ammonia is blocked by the molecular sieve assembly 210, and when the concentration of ammonia continuously increases, accumulates in the condensation cavity 201. According to a h-s diagram (a pressure-enthalpy diagram) of ammonia, the saturated pressure Pt of ammonia is 15 bar at 40° C., and the standby pressure of the separate quick-freezing equipment is set to be 2 Pt, namely 30 bar, thus, the ammonia concentration in the condenser 200 continuously increases; and when its concentration reaches 50%, namely, its partial pressure reaches 1 Pt, ammonia begins to condense to form liquid ammonia, which flows out of the liquid outlet. The liquid ammonia enters into the evaporator 100 along the liquid inlet pipe 230, hydrogen enters into the evaporator 100 along the gas inlet pipe 250, and the liquid ammonia and hydrogen are mixed in the evaporator 100. In the evaporator 100, since hydrogen is light to fill the evaporator 100, the partial pressure of ammonia approaches 0, molecules of the liquid ammonia may enter into the hydrogen to form ammonia, namely, the liquid ammonia evaporates, and the heat of the calcium chloride solution in the liquid storage tank 410 is absorbed, such that a calcium chloride solution of low temperature is prepared. The mixed gas of ammonia and hydrogen then returns to the condenser 200 along the gas returning pipe 220, thus achieving a circulation.

The calcium chloride solution flows in the circulating pipe 430, in the inner cavity of the quick-freezing box 420, the calcium chloride solution and the sodium chloride solution are subjected to heat exchange by means of the heat exchange component 432, so that the sodium chloride solution in the quick-freezing box 420 drops to a low temperature, and the sodium chloride solution may maintain in a liquid form below zero and is edible to be safe in contact with food materials, so that the freezing of food materials is quickly realized by using the low-temperature sodium chloride solution, and quick freezing is realized, and compared with liquid nitrogen quick freezing, the cost is greatly reduced, and the needs of large-scale operation are met. In addition, the separate refrigeration equipment changes the traditional refrigeration cycle mode, and the energy consumption during the condensation process is low, thereby reducing the production cost of a refrigeration system and having a large economic benefit.

It can be understood that an electronic expansion valve may be adopted as the throttling assembly 240, which is a throttling element capable of controlling the flow rate of the refrigerant in the refrigeration device according to a preset program. The electronic expansion valve controls the voltage or current applied to the expansion valve by means of an electric signal generated from regulated parameters, thus achieving the purpose of adjusting the liquid apply amount. The electronic expansion valve, as a novel control element, has become an import factor in refrigeration system intellectualization, is also an important means and guarantee for actually achieving refrigeration system optimization, and is applied to more and more pieces of refrigeration equipment.

Referring to FIG. 1, according to some embodiments of the present disclosure, the circulating pipe 430 is connected with a driving pump 431, which is located at an inlet end of the circulating pipe 430, so that the calcium chloride solution in the liquid storage tank 410 is driven by means of the driving pump 431 to rapidly flow through the circulating pipe 430, so as to form a forced convection, thereby increasing the heat exchanging efficiency and accelerating the quick-freezing process.

According to some embodiments of the present disclosure, the inlet end of the circulating pipe 430 is communicated with the lower part of the inner cavity of the liquid storage tank 410, the outlet end of the circulating pipe 430 is communicated with the upper part of the inner cavity of the liquid storage tank 410, and the inlet end and outlet end of the circulating pipe 430 are located at two opposite sides of the liquid storage tank 410.

According to some embodiments of the present disclosure, the inlet end of the circulating pipe 430 is communicated with the lower part of the inner cavity of the liquid storage tank 410, the outlet end of the circulating pipe 430 is communicated with the upper part of the inner cavity of the liquid storage tank 410, and the inlet end and an outlet end of the circulating pipe 430 are located at two opposite sides of the liquid storage tank 410. Since the calcium chloride solution has a temperature rise and tends to sink after the heat exchange achieved by the heat exchange component 432, and the sunk calcium chloride solution is cooled down after the heat exchange achieved by the heat exchange pipe 310, the inlet end of the circulating pipe 430 is provided below, and the cooled calcium chloride solution can be timely pumped, which is conducive to heat exchange with the sodium chloride solution by means of the heat exchange component 432 to obtain a low-temperature sodium chloride solution to freeze food materials, which is conducive to the speeding up of the freezing process, reduction of time consuming and effective preservation.

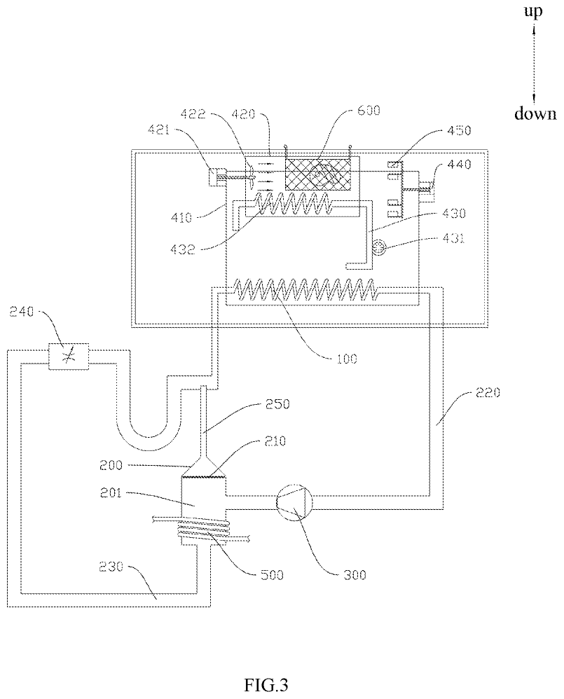

Referring to FIG. 3, according to some embodiments of the present disclosure, the heat exchange component 432 at the middle part of the circulating pipe 430 is configured as a heat exchange coil, which is located at the lower part of the inner cavity of the quick-freezing box 420, so that the contact area with the sodium chloride solution is increased by using the heat exchange coil, and the efficiency of heat exchange is increased, which contributes to the cooling of the sodium chloride solution.

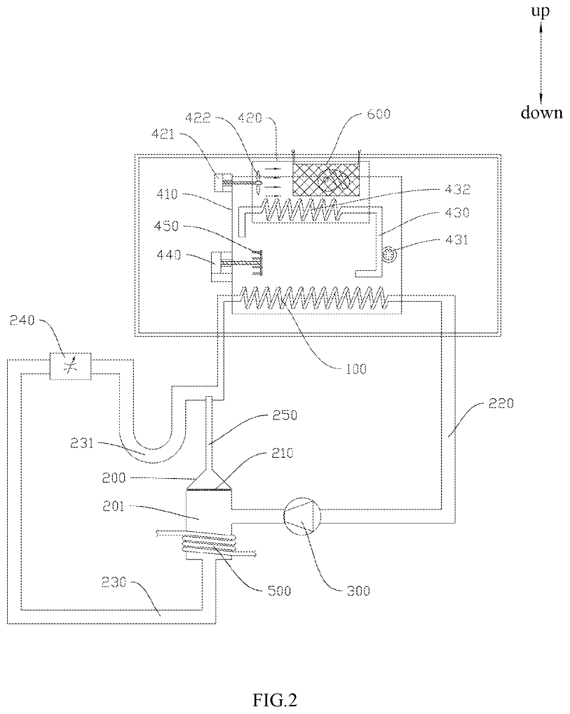

Referring to FIG. 2 and FIG. 3, according to some embodiments of the present disclosure, the quick-freezing box 420 is connected with a liquid driving module 421, the liquid driving module 421 has a driving motor and a propeller 422, the propeller 422 is located in the inner cavity of the quick-freezing box 420, and the driving motor drives the rotation of the propeller 422, thereby driving the sodium chloride solution to quickly flow, with the flow velocity more than 1 m/s and reaching a turbulent condition, which can substantially increase the heat exchange coefficient and accelerate the freezing. Furthermore, the direction in which the propeller 422 drives the flow of the sodium chloride solution is opposite to the direction in which the calcium chloride solution flows in the heat exchange component 432, which further increases the heat exchanging efficiency.

It can be understood that, in some embodiments of the present disclosure, the quick-freezing device also includes a food material box 600, which is used for storing food materials and made of a wire gauze, and can be put in the inner cavity of the quick-freezing box 420 and has a handle; the wire gauze can provide a circulation of the sodium chloride solution, and the freezing speed is improved combined with a driving action of the propeller 422. Furthermore, the food material box 600 has a handle to facilitate putting in and taking way food materials by user, which is facilitate the operation. The food material box 600 also plays a protective function that the heat exchange component 432 and the propeller 422 are separated to prevent the users from frostbite or injury due to the contact with the propeller 422, thus improving the safety.

Referring to FIG. 2, according to some embodiments of the present disclosure, the liquid storage tank 410 is connected with a stirring mechanism, which includes a motor 440 fixedly connected to the liquid storage tank 410, a rotating shaft of the motor 440 extends to the interior of the liquid storage tank 410 and is connected with a runner 450, the motor 440 drives the runner 450 to rotate by means of the rotating shaft, and the rotating runner 450 stirs the calcium chloride solution in the liquid storage tank 410 to improve the efficiency of heat exchange, which is conducive to cooling the calcium chloride solution. In a height direction, the runner 450 is located between the heat exchange pipe 310 and the circulating pipe 430, and stirs the calcium chloride solution to accelerate, at the same time, said solution contacting with the heat exchange pipe 310 and the circulating pipe 430, thus improving the heat exchange therein.

Referring to FIG. 3, according to some other embodiments of the present disclosure, in the height direction, the runner 450 is located on the upper portion of the liquid storage tank 410, even a portion of the runner 450 is located outside the liquid storage tank 410, and the runner 450 stirs the calcium chloride solution, which moves in the liquid storage tank 410 in a wide range, so that the heat transfer efficiency can also be improved.

According to some embodiments of the present disclosure, the liquid inlet pipe 230 includes a liquid storage section 231, which includes at least one U-shaped pipes. More refrigerants can be stored by installing the U-shaped pipes, so that the space occupied by the liquid inlet pipe 330 is reduced.

According to some embodiments of the present disclosure, the condenser 200 is connected with a heat dissipating device 500 to assist in heat dissipation. The heat dissipation efficiency of the condenser 200 can be effectively increased by installing the heat dissipating device 500, so as to further increase the condensation efficiency. The heat dissipating device 500 includes a cooling water pipe, which is wrapped outside the condenser 200, and a water source of normal temperature can be used in the cooling water pipe for safety taking. It can be understood that, an air cooled equipment instead of the cooling water pipe may be adopted as the heat dissipating device 500, or the air cooled equipment is used together with the cooling water pipe as the heat dissipating device 500.

According to some embodiments of the present disclosure, the gas outlet is located at the upper part of the condenser 200, the liquid outlet is located at the lower part of thy condenser 200, and the gas inlet is located at the middle part of the condenser 200. The gas with reduced pressure is lighter than the refrigerant and may flows upwards, the gas outlet is located at the upper part of the condenser 300 to facilitate the flowing out of the gas with reduced pressure, and the liquid outlet is located at the lower part of the condenser 300 to facilitate the flowing out of the liquefied refrigerant. The condenser 200 includes a tapered guiding portion, and the gas outlet is located at a small end of the tapered guiding portion. The gas with reduced pressure is guided to flow out of the gas outlet by installing the tapered guiding portion, so as to reduce the flow loss.

According to some embodiments of the present disclosure, a port of the gas inlet pipe 250 extends into the liquid inlet pipe 230, and projects from the inner wall of the liquid inlet pipe 230. The liquid ammonia enters from the left side, the hydrogen enters from the bottom, and a port of the gas inlet pipe 250 is set to project from the inner wall of the liquid inlet pipe 230, which can reduce the possibility of the liquid ammonia to flow backward from the gas inlet pipe 250 into the condenser 200.

According to some embodiments of the present disclosure, the blower device 300 includes a ventilator, in which a large compression ratio like a compressor in the conventional refrigeration system is not required, only the mixed gas is required to be introduced into the condenser 200, so as to achieve the condensation by concentration change of the refrigerant itself. Of course, a compressor may be adopted as the blower device 300, with the power less than that of the compressor of a conventional refrigeration system.

In practical application, the separate quick-freezing equipment is an integrated complete machine, which can be applied in places having a quick-freezing need such as seafood markets and shopping malls.

Embodiments of the present disclosure have been described in detail above in conjunction with the accompanying drawings, but the present disclosure is not limited to the above-mentioned embodiments, and various changes can also be made without departing from the spirit of the present disclosure within the scope of knowledge possessed by those of ordinary skill in the technical field.

1. A separate quick-freezing equipment, comprising:
an evaporator, having a refrigerant inlet and a refrigerant outlet;
a condenser provided with a condensation cavity, a gas inlet, a gas outlet and a liquid outlet, wherein the condensation cavity is internally provided with a molecular sieve assembly, the molecular sieve assembly is disposed between the gas inlet and the gas outlet and configured to separate mixed gas; the refrigerant outlet is connected to the gas inlet by means of a gas returning pipe, the liquid outlet is connected to the refrigerant inlet by means of a liquid inlet pipe, the liquid inlet pipe is provided with a throttling assembly, and the gas outlet is connected to the refrigerant inlet by means of a gas inlet pipe;
a blower device communicated with the gas returning pipe and configured to introduce mixed gas into the condensation cavity; and
a quick-freezing device comprising a liquid storage tank and a quick-freezing box, wherein the liquid storage tank is configured to store a first salt solution, the evaporator is located at a lower part of an inner cavity of the liquid storage tank, the quick-freezing box is located at an upper part of the inner cavity of the liquid storage tank, the quick-freezing box is configured to store a sodium chloride solution, the quick-freezing box is connected with a circulating pipe, both sides of the circulating pipe are communicated with the inner cavity of the liquid storage tank, and the circulating pipe is provided with a heat exchange component located within the quick-freezing box.

2. The separate quick-freezing equipment according to claim 1, wherein the circulating pipe is connected with a driving pump, the driving pump is located at an inlet end of the circulating pipe.

3. The separate quick-freezing equipment according to claim 2, wherein the inlet end of the circulating pipe is communicated with the lower part of the inner cavity of the liquid storage tank, an outlet end of the circulating pipe is communicated with the upper part of the inner cavity of the liquid storage tank, and the inlet end and outlet end of the circulating pipe are respectively located at two opposite sides of the liquid storage tank.

4. The separate quick-freezing equipment according to claim 1, wherein the heat exchange component is configured as a heat exchange coil, the heat exchange coil is located at the lower part of the inner cavity of the quick-freezing box.

5. The separate quick-freezing equipment according to claim 4, wherein the quick-freezing box is connected with a liquid driving module, and the liquid driving module has a propeller, the propeller is located in the inner cavity of the quick-freezing box to drive the sodium chloride solution to flow.

6. The separate quick-freezing equipment according to claim 5, wherein the quick-freezing device also comprises a food material box, the food material box is configured to store food materials and made of wire gauze, and is capable of being placed into the inner cavity of the quick-freezing box and has a handle.

7. The separate quick-freezing equipment according to claim 1, wherein the liquid inlet pipe comprises a liquid storage section, the liquid storage section comprises at least one U-shaped pipes.

8. The separate quick-freezing equipment according to claim 1, wherein the condenser is connected with a heat dissipating device for heat dissipation, and the heat dissipating device comprises a cooling water pipe, the cooling water pipe is wrapped at outside of the condenser.

9. The separate quick-freezing equipment according to claim 1, wherein the gas outlet is located at an upper part of the condenser, the liquid outlet is located at a lower part of the condenser, the gas inlet is located at a middle part of the condenser, the condenser comprises a tapered guiding portion, and the gas outlet is located at a small end of the tapered guiding portion.

10. The separate quick-freezing equipment according to any claim 1, wherein a port of the gas inlet pipe extends into the liquid inlet pipe, and projects from an inner wall of the liquid inlet pipe.
